(19) United States
(12) Patent Application Publication
(10) Pub. No.: US 2003/0236777 A1
(43) Pub. Date: Dec. 25, 2003

(54) System and method for managing internet transactions

(76) Inventor: Shevin Conway, New York, NY (US)

Correspondence Address: Gibson, Dunn & Crutcher LLP, Suite 4100, 1801 California Street, Denver, CO, 80202, US

(21) Appl. No.: 10/360,555

(22) Filed: Feb. 7, 2003

Related U.S. Application Data
(60) Provisional application No. 60/355,226, filed on Feb. 7, 2002.

(51) Int. Cl. G06F 7/00

(52) U.S. Cl. 707/3

(57) ABSTRACT

A system and method for seamlessly performing Internet transactions with real-time feedback is discloses. The system and method comprises a process for monitoring and managing Internet transactions that stores and queues transactions when processing is not available transactions and flags transactions requiring outside intervention. Transactions are monitored by storing one or more attributes relating to the transaction and creating a transaction record by storing the collected attributes relating to a transaction into a single entry having a locally unique identifier. The transaction record is monitored until a finalized transaction status is detected. Until a transaction is finalized, real-time reports as to a transaction status are sent to the party requesting the transaction. The system and method incorporates functions that greatly increase the probability of successful Internet transactions, including circumstances where the transaction requires communication via the Internet with a Legacy System.

System and method for performing seamless transactions over the Internet with real-time feedback as to the status of transmitted transaction requests. This application claims priority from provisional application serial No. 60/355,226 filed on Feb. 7, 2002.

### BACKGROUND OF THE INVENTION

1. Field of the Invention

The invention relates to Internet transactions and more specifically to managing and monitoring transaction requests sent via the Internet to a host.

2. Description of the Related Art

The access to information and communications, provided by the Internet has fueled its explosive growth. Documents, messages and information that would previously have been sent via postal mail, over night delivery, or facsimile are now sent over the Internet. The ability to instantaneously communicate over the Internet has forever changed business practices.

Modem businesses have recognized that the Internet is not only a means of sending information; it can also be a tool for processing transactions. In the most basic situation Internet users contact each other by email and from the information shared can transact with each other. If, by chance, both parties are online at the same time the parties can transact with each other in real-time. On a slightly higher level, consumers can now go to virtual stores and purchase items via virtual shopping transactions. In this situation, the consumer views a company's available products over the Internet and by filling out the appropriate information the consumer can purchase desired items. The company selling the products receives the customer's request fills the order and emails the consumer a confirmation of the order. Virtual shopping shows how at a most basic level the Internet can be used for transaction processing.

On a more complex level, it is now common for businesses to maintain Internet hosts, which are designed to perform real-time processing of transaction requests received via the Internet. In a common situation, a client of the company, an end-user, enters information into a data terminal. Most data terminals are personal computers and the client information could be entered onto the data terminal via a company web page or through a software management system. The data terminal is in turn connected to the Internet through a web portal. The information submitted by the client is transferred from the data terminal to the company's host (“Company-Host”) via the Internet. The Company Host receives and then processes the end-user's data. After processing the data, the Company Host communicates a result to the end-user via the Internet. Such a transaction between an end-user and host occurs in real-time without the need for manual intervention. Consequently, the Internet provides a simple and efficient method for performing real-time transactions.

Several problems currently exist that reduce the effectiveness of Internet transactions. Many companies have applications and data stored on older legacy systems, which cannot be effectively accessed from the Internet. Another common problem with transactional methods that utilize the Internet is host unavailability. A company's host may be off-line to an end-user because of connection problems, limited capacity to process concurrent requests or various other reasons. In such situations, the host may send a message informing the end-user that the transaction cannot be processed or, in the worse case scenario, the transaction is not processed and the end-user is unaware of the failure of the transaction.

In many fields of business, including the insurance industry, it is common for an end-user to enter a large batch of individual transactions at one time. In such situations, if the applicable hosts are unavailable and do not process some of the transactions, the end-user has the responsibility of determining which transactions were processed and resubmitting unresolved transaction requests. Similarly, under the current state of the art, an end-user that is continuously generating information for processing by a host has to independently keep track of the information that has been submitted and successfully processed to ensure processing of all transactions. Under the current state of the art, end-users submitting multiple transaction batches or continuous transaction requests only receive feedback if the transaction is either successful or unable to be processed by the host. This leaves long periods of time when the end-user is unsure of the status of a transaction. Additional problems associated with Internet transaction systems occur when an end-user provides too little, or incorrect information to the host and, as a consequence, the requested transaction cannot be processed. These problems are detrimental to the end-user who has to spend time manually resubmitting transaction requests that have failed because of host unavailability and assessing the status of transaction requests to ensure all requests in a batch etc are processed.

Consequently, there is a need, especially in the insurance industry, for a method of managing end-user-host transactions so that transactions requests are seamlessly delivered to the host for processing and real-time status reports concerning individual requests are provided to the end-user.

### BRIEF SUMMARY OF THE INVENTION

The following invention addresses the above-mentioned needs in the art by providing a method for an end-user to seamlessly submit information from their data terminal via the internet, have the information processed/adjudicated by a host and receive real time status regarding the submitted information.

Specifically, the claimed invention stores an attribute from each transaction request submitted by an end-user. An attribute may comprise of the entire transaction request, an identifier associated with the transacting agent—i.e. a web address—or it could be a requirement of the transaction—i.e. needs system available or the transaction data needs. In turn, each stored attribute is given a unique identification. The storing and identification of attributes occurs in a middle tier. Once an attribute from a transaction has been stored and identified, a request is sent to the company host via the middleware. A polling process then begins periodically checking the status of all requests. If the polling process detects that a request has successfully been processed by the company host it is considered finalized and a message is sent to the end-user along with the result of the adjudication. If the request is not finalized because of host unavailability the request is stored and resubmitted when the host is back online. If, however, the host is unable to adjudicate the request because of problems other than unavailability an error report is generated and sent to the end-user to prompt external intervention.

In this way, the method provides the end-user with real-time feedback regarding the status of their request. The process also stores requests for resubmitting to the host, taking this task and the associated problems out of the hands of the end-user. In summation, the method provides a method for providing seamless Internet transactions for an end-user.

### BRIEF DESCRIPTION OF THE FIGURES

FIG. 1 is a block diagram illustrating a preferred embodiment of the present invention.

FIG. 2 shows a schematic/block diagram of a computer system.

FIG. 3 is a flow diagram illustrating the flow of information between the end-user and an online host in a preferred embodiment of the invention.

FIG. 4 is a flow diagram illustrating the flow of information between an end-user and an offline host in a preferred embodiment of the invention

FIG. 5 is a flow diagram illustrating side-by-side comparisons of the flow of a transaction through a preferred embodiment of the invention

FIG. 6 illustrates the processes occurring as a transaction is processed in the different layers of a preferred embodiment of the invention

### DETAILED DESCRIPTION OF THE INVENTION

Reference will now be made in detail to the construction and operation of preferred implementations of the present invention illustrated in the accompanying drawings. In those drawings like elements and operations are designated with the same reference numbers when possible.

The following description of the preferred implementations of the present invention is only exemplary of the invention. The present invention is not limited to these implementations, but may be realized by other implementations.

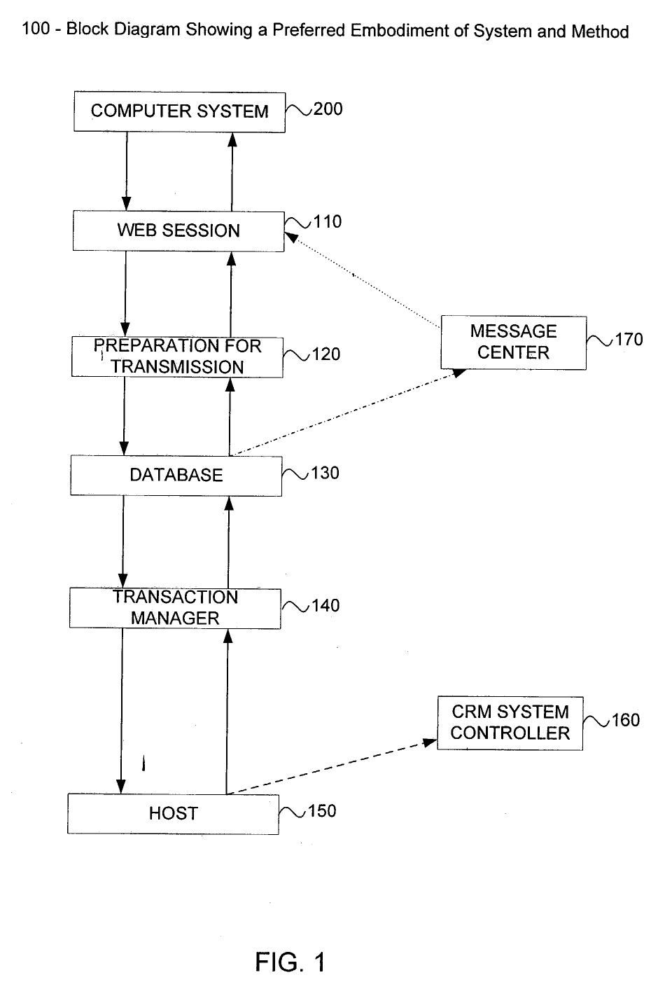

FIG. 1 is a functional block diagram showing a system 100 for synchronous and asynchronous transaction management with real-time feedback of transaction status in accordance with the present invention.

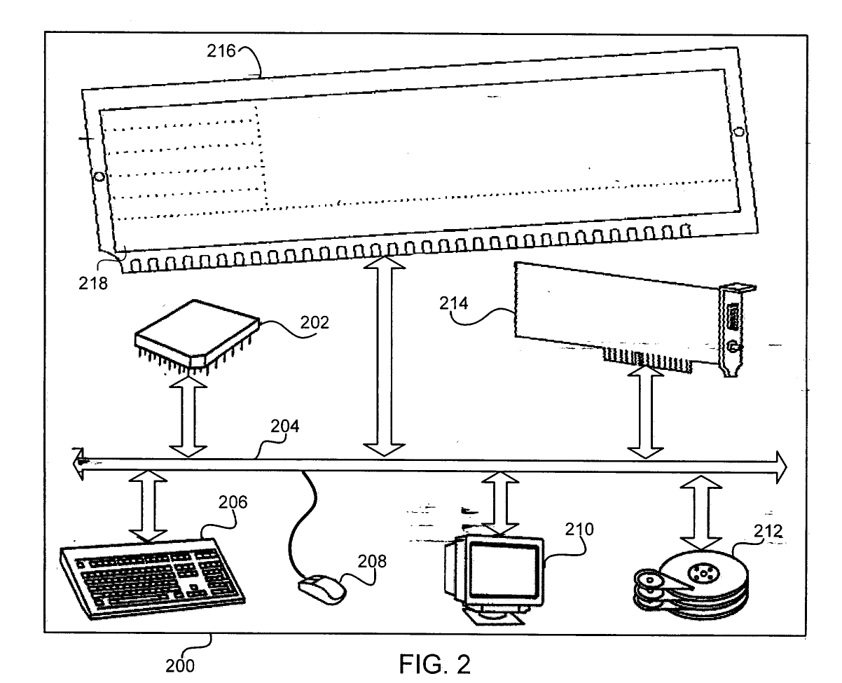

By way of example, a computer system 200 is connected to the internet via a web portal 120. FIG. 2 shows a basic computer system 200. The computer system 200 contains a Processing Element 202. The Processing Element 202 communicates to other elements of the Computer System 210 over a System Bus 204. A Keyboard 206 allows a user to input information into Computer System 200, and a Graphics Display 210 allows Computer System 200 to output information to the user. Graphical Input Device 208, which may be a mouse, joy stick, or other type of pointing device, is also used to input information. A Storage Device 212 is used to store data and programs within Computer System 200. A Memory 216, also connected to System Bus 204, contains an Operating System 218, and relevant Software 220. A Communications Interface 214 is also connected to System Bus 204. Communications Interface 214 may have one or more serial ports, parallel ports, infrared ports, and the like. Connectable through Communications Interface 214 may be an external printer or scanner, as well as access to a computer network (LAN or WAN), to the Internet, or to any other appropriate communication channel (not shown in FIG. 1).

The requesting agent enters information into the computer system 200 and submits a transaction request via a web portal 110. In the medical-insurance industry, the requesting agent may be a physician's office, medical center, hospital etc and the relevant software 220 in the computer system 200 might be the Physician Office and Management System (“POMIS”). In a preferred embodiment of the invention, the Web Portal reviews the information entered by the requesting agent in real time for embedded viruses and errors. Also, Web Portal verifies the authority of the requesting agent to access the Host. In a preferred embodiment of the invention, the formats and field sizes of all data elements of the information entered by the requesting agent are analyzed by the Web Portal and mis-keyed or erroneous data is brought to the attention of the requesting agent. In this way, any submitted request with incompatible data is halted and a notice highlighting the incompatible data is returned to the requesting agent.

In the preferred embodiment of the invention, the Web Portal creates a string of the data submitted by the requesting agent and this string is converted through a real-time transaction into the appropriate entry format for the Host 150. A secure Internet protocol is utilized to deliver the data string to the Host 150. The system and method may utilize a fail-over mechanism. For example, a string image of every transaction request could be stored in a database.

In the preferred embodiment, the computer system is connected to the Host 150 by a middleware bridge. A transaction record is created by storing one or more attributes relating to the requesting agent's transaction into a single entry having a locally unique identifier. The stored attribute may be an identifier associated with the transacting agent—i.e. a web address —or it could be a requirement of the transaction—i.e. needs system available or the data needs. The identifier could be a database entry address, a pointer to memory location, an offset value, or other methods that can be used to establish a locally unique identifier for the stored data. Not all attributes need necessarily be stored, only attributes relating to the requested host or process. In the preferred embodiment of the invention, the attribute or attributes relating to the requested host process are stored in the Database 130 and given a unique identification. The fact that the attributes are stored in separate instances of the same database guarantees this uniqueness. In the preferred embodiment of the invention, an identifier associated with the requesting agent or the person for whom the request is made; i.e. a social security number, name, address or telephone number, is also stored in the Database 130.

In the middleware, an initial tier of the system 120 prepares and formats the requesting agent's submitted transaction for transmission to the Host 150. While this invention will be described with reference to managing an assortment of transactions, the invention would also be applied in such a way that only related transactions are managed by the same transaction manager. By way of example, the initial tier of the system 120 may use Enterprise Java Beans (“EJB”) to access the database associated with the Host 150. (Java Beans is a trademark of Sun Microsystems, In.). As persons familiar with the art are aware, a Java Bean can be used to access data or applications that create data, from a legacy host or database.

The Transaction Manager 140 transmits the formatted transactions to the host 150. A host is a unit that includes at least one processor and one or more instructions associated with a process performed by the host. For example, a host may be an “update host” that updates entries to a particular database. While the word host implies singularity, the “host” unit may comprise one or more actual processing units that may be physically separated or otherwise distributed on a given network. Finally, the designation of a processing unit as a “host” in one transaction does not restrict the host from serving as an initiating agent in the same or related transactions. For example, a given host may submit requests to one or more host “subprocessing” machines. As a result, a single requested transaction could result in transaction entries for different layers of processing. Alternatively, there could be only a single transaction record that includes each host that will be used (whether directly or as a “subprocess” host) to complete the requested transaction.

When the Host 150 is available, it receives and can commence processing the transaction request sent by the requesting agent via the middleware bridge. The preferred embodiment of the system and Method of the Legacy Data Conversion as described in Appendix 1. Utilizing the invention described in that patent, seamless communication with a legacy host is possible because, in accordance with the incorporated invention, legacy data stored in the Host 150 is converted into XML formatted data that can be used directly by an XML based middleware layer with little transactional overhead.

If the Host 150 is available the requested transaction is processed and the response from the Host 150 is sent, via the middleware bridge, back to the Computer System 200 where the result can be viewed by the transacting agent. The response of the Host 150 is also sent to the Message Center 170 where it can be viewed by the transacting agent at a later time or by parties other than the transacting agent who have access to the Message Center 170. A transaction cannot be processed either synchronously or asynchronously when the Host 150 is available, but is unable to perform the requested transaction because of problems with the data entered into the computer system by the requesting agent. In this event, the transaction request is sent to a Customer Relationship Management (“CRM”) system controller 160 for re-formatting by the requesting agent and the transaction record is moved from its current location in logical memory. In the preferred embodiment of the invention, the transaction record is removed from the Database 130.

FIG. 1, shows the flow of information through the invention when the requested transaction has been submitted to and successfully executed by the host 150. Once this has occurred the transaction record is moved from its current location in logical memory. In the preferred embodiment of the invention the Database is updated to show that the transaction has been successfully completed. Upon successful execution of a transaction, the host's response to the initiating agent's transaction is translated by the middleware and communicated via the Web Portal 110 to the initiating agent during the current web session. For example, if the Host 150 reports that it has successfully completed a transaction involving the alteration of an address field, the success response would be translated into a success message that would then be communicated to the initiating agent (i.e. “You have successfully updated your address”). A transaction identifier could also be supplied in connection with such message in the event that the transaction record is requested.

In the current state of the art, it is normal for transactions to be processed in a purely bidirectional mode—X requests a transaction from host Y which in turn performs the transaction and sends the result to X. If X has ended the web session prior to the transaction being processed the information is commonly only available to X at the next web session on the Computer System. In many situations, however, person's other than the requesting agent X may need to have access to the results of an Internet transaction. For example, in the medical industry a doctor, patient, nurse or office manager may all need to see the status of a request for insurance coverage sent to the patient's insurer. Moreover, these people may not have access to the requesting agent's computer system. Consequently, in the preferred embodiment of the invention, the Host's response to a transaction request is also sent to a message center. The transaction responses in the message center may be made accessible to anybody with the appropriate access information.

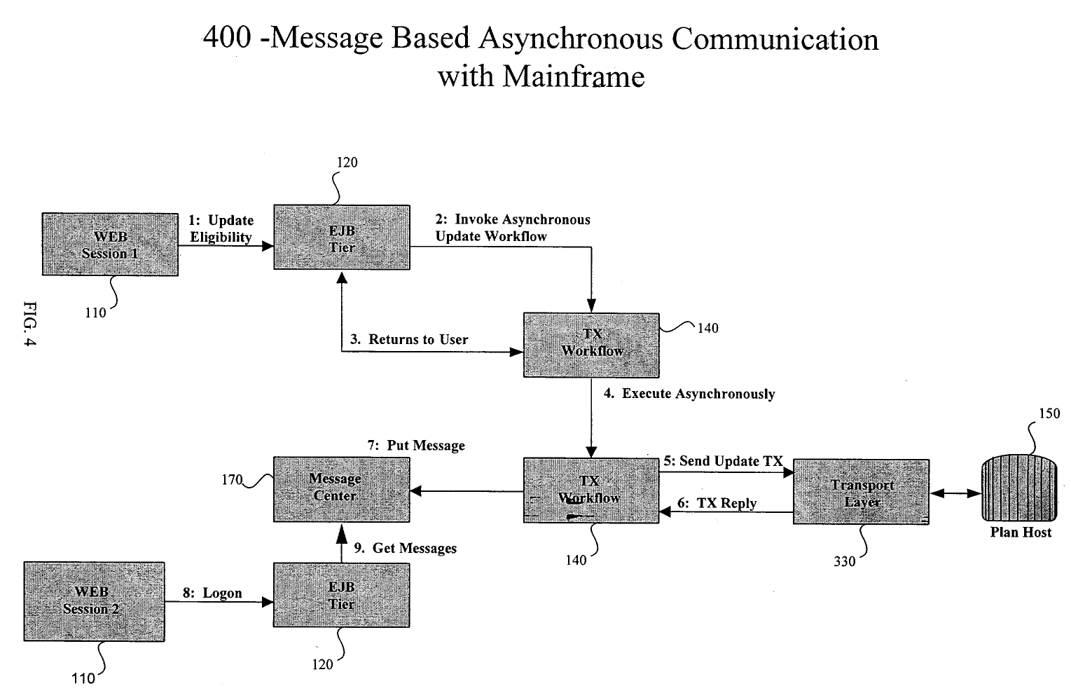

If, as in FIG. 4, the Host 150 is not available when the requesting agent submits the transaction request. In this situation, the transaction record is not moved from its current location in logical memory. In the preferred embodiment of the invention the transaction identifier in the Database 130 is not updated.

In a process called polling, the status of all claims is continually being tested. In the preferred embodiment of the invention, the transaction identifiers in the Database are continually tested to determine the status of the requested transactions. One or more of the transaction records that include attributes associated with the unavailable Host 150, prompt the Transaction Manager 140 to test the availability of each identified host. When, according to the attributes of the transaction records, the Host 150 is considered unavailable, the Transaction Manager 140 periodically monitors the availability of the Host 150.

Responsive to a test result that increases the probability that the Host 150 is available, the Transaction Manager 140 re-submits a transaction to the identified Host 150. For example, if a given set of host machines has a regular maintenance schedule, the availability of one host machine in the set would increase the probability that other host machines in the set are also available. Furthermore, as a result of network communication delays (lag), a reply from a host machine that is available only establishes that the host was available at the time that the test results were transmitted. Finally, the “availability” of a given host may be determined (at least in part) based on the availability of other hosts.

If the identified Host 150 is available and the host successfully executes the transaction, the transaction record is moved from its current location in logical memory. In the preferred embodiment of the invention, once the transaction is executed the Database 130 is updated to show that the transaction has been successfully executed, which may include deletion of the entry from the Database 130. Furthermore, in the preferred embodiment of the invention, if the initiating agent is still online, the host's response to the executed transaction is communicated to the initiating agent during the current web session. However, if the transaction management system determines that the initiating agent is offline, the host's response is communicated to a message center 170, (such as an electronic mail address), which in turn informs the initiating agent of the host's response to the transaction at the beginning of the initiating agent's next web session.

In the preferred embodiment of the invention, a polling process periodically checks the status of all unfinalized transactions. In this way a status report can be created and sent to the Message Center 170 to provide real time feedback to the initiating agent regarding all submitted transactions. The Message Center may comprise any method of displaying the transaction status or the processed transaction, such as a web page where the status/results of requested transactions are posted and updated. The Message Center 170 may be viewed by the requesting agent or any other person provided with access. Alternatively, instead of the Message Center 170, there may be direct communication with the transacting agent, for example, instant messages regarding the status and results of a transaction may be sent to the transacting agent or a wireless communication method may be used to update the transacting agent regarding the status and results of a transaction request. In a preferred embodiment of the invention, the requesting agent is provided with status and transaction result updates in real-time. In the preferred embodiment of the invention, if the transaction cannot be executed because of a non-recoverable error an error report is generated in order to prompt manual intervention.

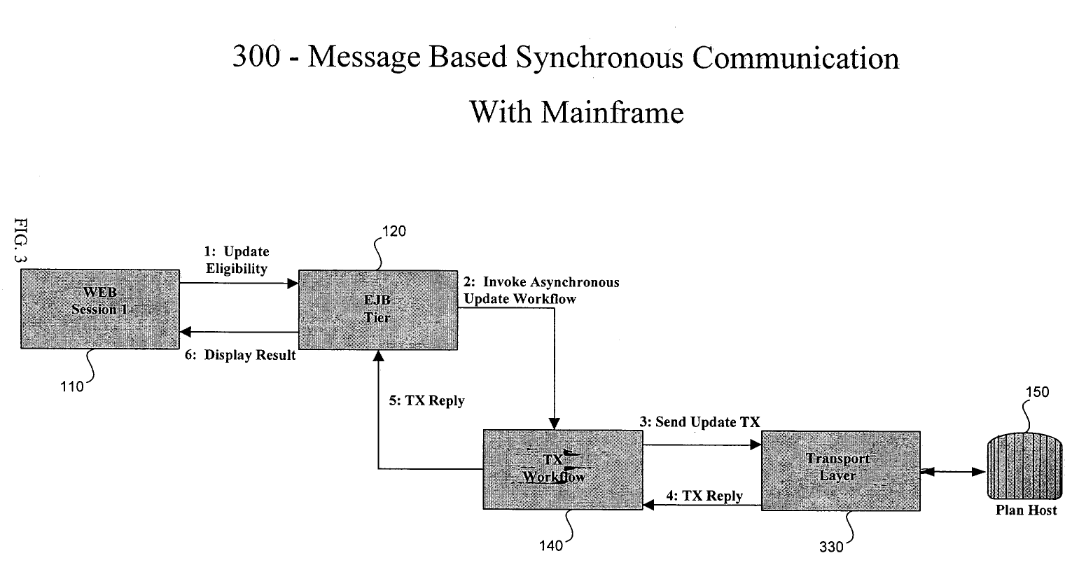

FIG. 3 shows a flow diagram of a preferred embodiment of the system and method when there is synchronous communication between the requesting agent and the required host 150.

The requesting agent submits a transaction, during a web session, via a web portal 110. In the preferred embodiment, the transaction management process is performed in the Enterprise JavaBeans® (“EJB”) tier 120, which transforms the transaction into a format that is appropriate for the identified host although any similarly functional alternative could also be used. The Transaction Manager 140 tests the availability of the required Host 150. In this diagram, the Host 150 is available, therefore, the Transaction Manager 140 submits the transaction to the identified Host 150 via a Transport Layer 330. In turn, the Host 150 executes the transaction and sends a reply to the Transaction Manager 140. The Transaction Manager 140 identifies that the transaction has occurred synchronously and sends the hosts reply to the EJB tier 120. The EJB tier 120 translates the Host's reply into a format that is appropriate for the web portal. The host's reply to the transaction is then displayed on the Web Portal 110 for the initiating agent during the web session.

FIG. 4 shows a flow diagram of a preferred embodiment of the system and method when there is asynchronous communication between the requesting agent and the required host.

The initiating agent submits a transaction, during a web session, via a Web Portal 110. The Enterprise EJB tier 120 transforms the transaction into a format that is appropriate for the identified Host 150. The Transaction Manager 140 tests the availability of the required Host 150. In this diagram the Host 150 is unavailable, therefore, the Transaction Manager 140 queues the transaction and does not update the applicable database. The Transaction Manager 140 periodically tests the availability of the required Host 150. Once the Transaction Manager 140 identifies that the required Host 150 is available it sends the transaction to the identified host via the Transport Layer 330. In turn, the Host 150 executes the transaction and sends a reply, via the Transport Layer 330, to the Transaction Manager 140. The Transaction Manager 140 identifies that the transaction has occurred asynchronously and sends the host's reply to a Message Center 170. Thus, when the initiating agent retrieves messages during a subsequent web session, it will receive host's reply to the transaction.

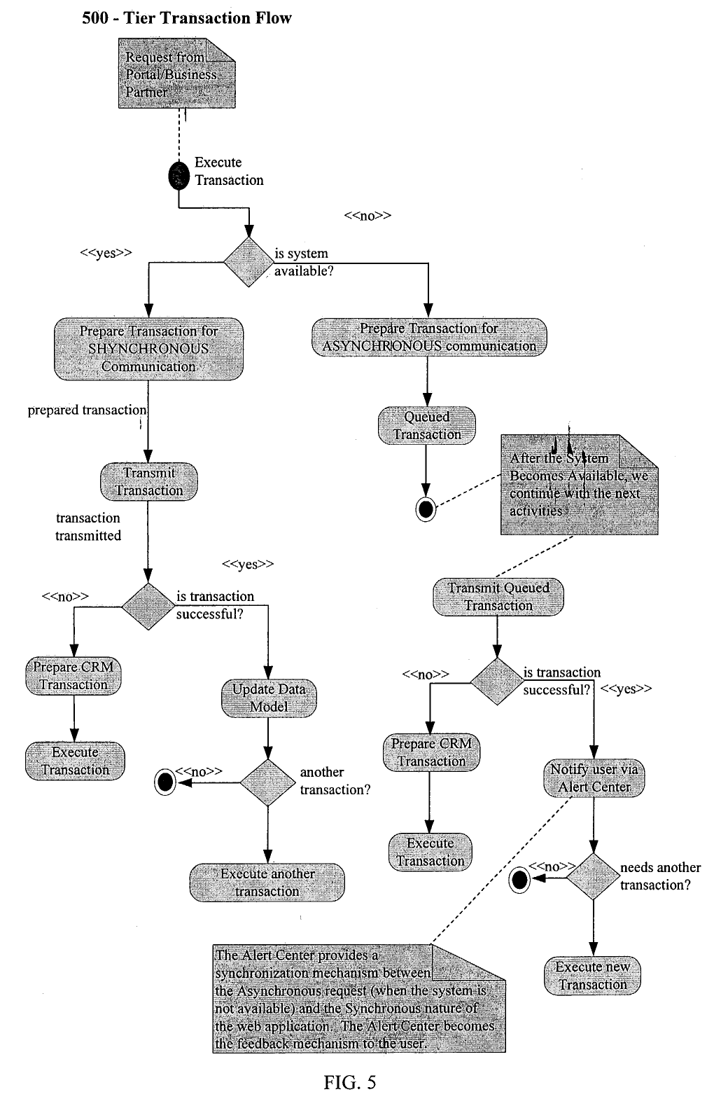

FIG. 5 shows a flow diagram and side-by-side comparison, of preferred embodiments of the invention, for synchronous and asynchronous communication between the initiating agent and the host.

As discussed previously, a transaction/request or transactions/requests are sent via a web portal to a host. The Transaction Manager, part of the middleware, identifies the required host or hosts and determines whether the identified host is available.

If the Host is available, the transaction/request is prepared for synchronous communication with the host. The prepared transaction/request is then transmitted to the host. The Transaction Manager monitors whether the transaction/request has been successfully executed by the host. If the transaction/request is not executed the transaction/request is prepared again and resubmitted to the host until successfully executed. Once the transaction/request is executed by the host, the data model is updated and if transaction/request is a part of a batch, the next transaction/request is executed until all of the batch of transactions/requests have been executed.

If the host is unavailable, the transaction/request is prepared for asynchronous communication. The transaction/request is queued until the host becomes available. When the host is available the queued transaction/request is transmitted to the host. The Transaction Manager monitors whether the transaction/request has been successfully executed by the host. If the transaction/request is not executed the transaction/request is prepared again and resubmitted to the host until successfully executed. Once the transaction/request is executed by the host an alert center is notified, which provides feedback to the initiating agent that its transaction/request has been successfully executed. If the transaction/request is a part of a batch all of the batch of transactions/request are executed and the alert center is informed that the entire batch has been executed and the initiating agent is informed of this result via the alert center.

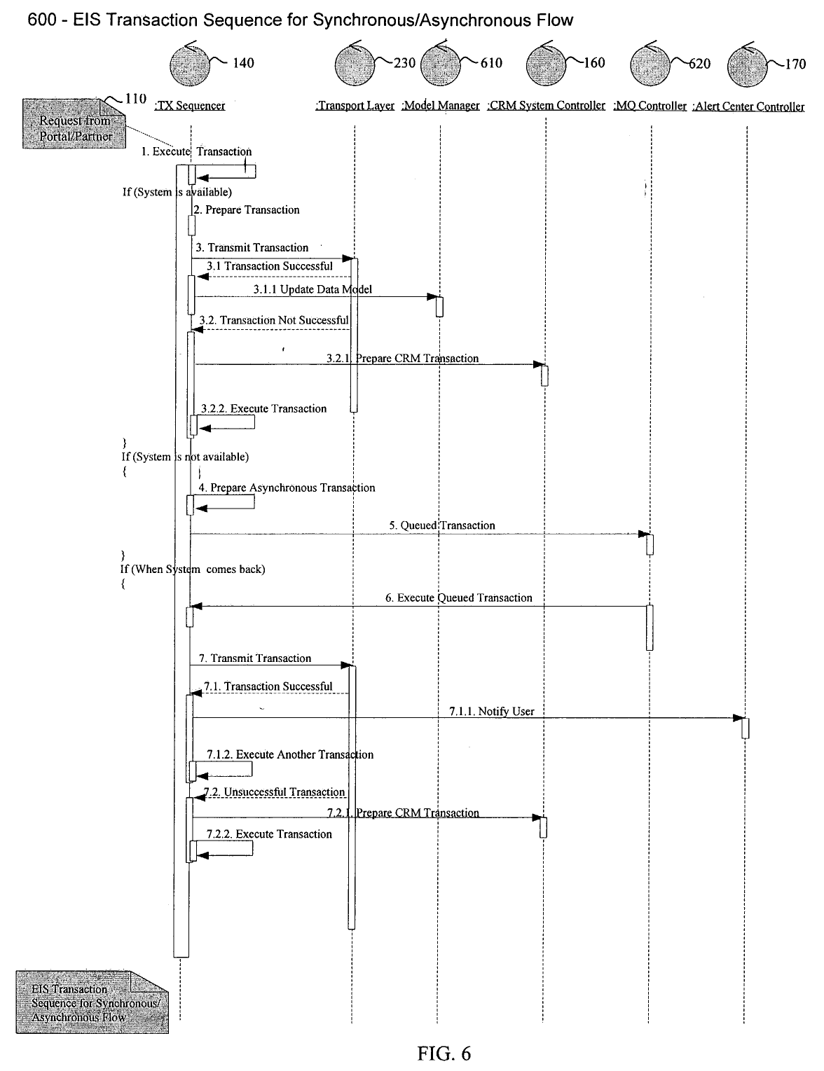

FIG. 6 separates the elements of a preferred embodiment of the invention and shows how they are involved in the process and method.

Every time a request is made via a Web Portal 110, the Transaction Manager 140 determines whether the system is available.

If the system is available, the Transaction Manager 140 prepares the request for a synchronous transaction with the system and immediately submits the request to the system via the Transport layer 330. If the request is successfully executed the Transaction Manager 140 updates the data model. If the request is not successfully executed, the request is sent to the CRM system controller 160 for modification and reformatting. After the request has been modified by the CRM system controller 160 it is sent back to the Transaction Manager 140. The Transaction Manager 140 then resubmits the request to the system repeating the process with the CRM system controller 160, as necessary, until the transaction is executed and the Model Manager 610 updates the data model.

If the system is unavailable the Transaction Manager 140 prepares the request for an asynchronous transaction with the system. The Transaction Manager 140 sends the request to the MQ (“Message Queue”) Controller 620 for queuing. The Transaction Manager 140 monitors the system and once it determines that the system is available, the queued request is immediately transmitted to the system via the Transport Layer 330. If the request is successfully executed by the system the Transaction Manager 140 notifies the user. If the request is not successfully executed the Transaction Manager 140 submits the request via the transport layer 330 to the CRM system controller 160, which makes modifications, as necessary, to the request. The re-formatted request is then returned to the Transaction Manager 140, which sends the request via the Transport Layer 330 to the system, repeating the process with the CRM system controller 160 as necessary until the request is executed. Once the request is executed, the Transaction Manager 140 sends a message via the transport layer 330 to the requesting agent.

The foregoing description of the preferred embodiments of the invention has been presented for the purposes of illustration and description. For example, although described with respect to the insurance and healthcare industries, the system and method could be used in other industries or for nonbusiness reasons. Additionally, the claimed system and method should not be limited to the particular embodiments disclosed. The descriptions of the header structures should also not be limited to the embodiments described. For these reasons, this description is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system and method for managing transactions that are initiated by a requesting agent and submitted to one or more hosts wherein, responsive to one or more hosts being unavailable, a method is performed comprising the steps of:
a. storing one or more attributes relating to the requested transaction;
b. creating a transaction record by storing the collected attributes relating to a transaction into a single entry having a locally unique identifier;
c. responsive to the presence of one or more transaction records that include attributes associated with an unavailable host, periodically testing the availability of such identified host;
d. responsive to a test result that increases the probability that the host is available, transmitting the transaction request to the host; and
e. responsive to successful processing of the transaction by the host, moving the transaction record from its current location in logical memory.

2. The method of claim 1, further comprising a message center where the status of said requested transactions is updated in real-time.
